(19) United States
(12) Patent Application Publication
(10) Pub. No.: US 2007/0135047 A1
(43) Pub. Date: Jun. 14, 2007

(54) Method and apparatus for transmitting information of image forming apparatus

(75) Inventor: Hye-jin Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/545,531

(22) Filed: Oct. 11, 2006

(30) Foreign Application Priority Data
Dec. 8, 2005 (KR) 2005-0120114

(51) Int. Cl. H04B 7/00

(52) U.S. Cl. 455/41.2

(57) ABSTRACT

A method and apparatus for transmitting information of an image forming apparatus are provided. The method includes receiving wireless headset identification information, transmitting information of an image forming apparatus to a headset corresponding to the wireless headset identification information and outputting the image forming apparatus information to a speaker of the headset as a voice message. Accordingly, it is possible to inform a user in the vicinity of a printer of various printer state information such as information whether a print operation performed by the printer has been terminated and thus maximize user convenience by transmitting the printer state information directly to a headset without the need to transmit the printer state information first to the user's mobile phone.

### CROSS-REFERENCE TO RELATED PATENT APPLICATION

This application claims the benefit under 35 U.S.C. §119(a) of Korean Patent Application No. 10-2005-0120114, filed on Dec. 8, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a method and apparatus for transmitting information of an image forming apparatus.

2. Description of the Related Art

With the increase in the number of users using Bluetooth headsets, it becomes more necessary to notify a user of various information regarding the state of an image forming apparatus such as printer, including information indicating whether a print operation has been terminated and information indicating whether paper jam, paper out, or toner out has occurred. Conventionally, such printer state information is transmitted to a mobile communication terminal such as a cell phone, and then, the mobile communication terminal transmits the printer state information to a headset.

However, in order to maximize user convenience, it is necessary to inform a user of various printer state information by transmitting the printer state information directly to a headset without the need to transmit the printer state information to the user's cell phone.

Accordingly, there is a need for an improved method and apparatus for transmitting information of an image forming apparatus directly to a headset.

### SUMMARY OF THE INVENTION

Exemplary embodiments of the present invention address at least the above problems and/or disadvantages and provide at least the advantages described below. Accordingly, an aspect of the present invention is to provide a method and apparatus for transmitting information of an image forming apparatus in which information of an image forming apparatus is directly transmitted to a headset.

Exemplary embodiments of the present invention also provide an image forming apparatus for transmitting information of an image forming apparatus.

Exemplary embodiments of the present invention also provide a headset for transmitting information of an image forming apparatus.

According to an exemplary aspect of the present invention, there is provided a method of transmitting information of an image forming apparatus. The method includes receiving wireless headset identification information and transmitting information of an image forming apparatus to a headset corresponding to the wireless headset identification information and outputting the image forming apparatus information to a speaker of the headset as a voice message.

The wireless headset identification information may be input via a user interface.

The transmission may include transmitting the image forming apparatus information to a Bluetooth headset using a Bluetooth protocol.

The image forming apparatus information may include state information of the image forming apparatus and error information regarding errors that may occur in the image forming apparatus.

The outputting may include receiving the image forming apparatus information from the image forming apparatus, determining whether the headset is currently in use and, if the headset is currently not in use, outputting the image forming apparatus information to the headset speaker as a voice message and if the headset is currently in use, terminating the use of the headset and outputting the image forming apparatus information to the headset speaker as a voice message.

The termination of the use of the headset and the outputting of the image forming apparatus information may include, if the headset is currently in use, outputting the image forming apparatus information to the headset speaker after the use of the headset is terminated.

The use of the headset may include use of the headset for making/receiving a call and use of the headset for listening to music.

According to another exemplary aspect of the present invention, there is provided an apparatus for transmitting information of an image forming apparatus. The apparatus includes an information transmission unit which, when wireless headset identification information is received, transmits information of an image forming apparatus to a headset corresponding to the wireless headset identification information and an information output unit which outputs the image forming apparatus information to a speaker of the headset as a voice message.

The apparatus may also include a user interface unit which receives the wireless headset identification information from a user, wherein the information transmission unit transmits the image forming apparatus information to the headset speaker when receiving the wireless headset identification information.

The information transmission unit may transmit the image forming apparatus information to a Bluetooth headset using a Bluetooth protocol.

The image forming apparatus information may include state information of the image forming apparatus and error information regarding errors that may occur in the image forming apparatus.

The information output unit may include an information receiver which receives the image forming apparatus information from the image forming apparatus, an in-use checker which determines whether the headset is currently in use and an information transmitter which, if the headset is currently in use, terminates the use of the headset and outputs the image forming apparatus information to the headset speaker as a voice message, and, if the headset is currently not in use, outputs the image forming apparatus information to the headset speaker as a voice message.

If the headset is currently in use, the information transmitter may output the image forming apparatus information to the headset speaker after the use of the headset is terminated.

The use of the headset may include use of the headset for making/receiving a call and use of the headset for listening to music.

According to another exemplary aspect of the present invention, there is provided an image forming apparatus. The image forming apparatus includes a user interface unit which receives headset identification information from a user and an information transmission unit which, when the headset identification information is received, transmits information of the image forming apparatus to a headset corresponding to the headset identification information.

The information transmission unit may transmit the image forming apparatus information to a Bluetooth headset using a Bluetooth protocol.

According to another exemplary aspect of the present invention, there is provided a headset. The headset includes an information receiver which receives information of an image forming apparatus, an in-use checker which determines whether the headset is currently in use and an information transmitter which, if the headset is currently in use, terminates the use of the headset and outputs the image forming apparatus information to a speaker of the headset as a voice message, and, if the headset is currently not in use, outputs the image forming apparatus information to the headset speaker as a voice message.

If the headset is currently in use, the information transmitter may output the image forming apparatus information to the headset speaker after the use of the headset is terminated.

The information receiver may receive the image forming apparatus information using a Bluetooth protocol.

According to another exemplary aspect of the present invention, there is provided a computer-readable medium storing a computer program for executing the method of transmitting information of an image forming apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an exemplary image forming apparatus of the present invention;

FIG. 2 is a diagram of an exemplary headset for a mobile communication terminal and an exemplary image forming apparatus of the present invention;

FIG. 3 is a block diagram of an apparatus for transmitting information of an image forming apparatus to a headset according to an exemplary embodiment of the present invention;

FIG. 4 is a diagram of an example of a user interface unit of FIG. 3;

FIG. 5 is a block diagram of an information transmission unit of FIG. 3;

FIG. 6 is a flowchart illustrating a method of transmitting information of an image forming apparatus to a headset according to an exemplary embodiment of the present invention;

FIG. 7 is a flowchart illustrating a method of obtaining information of an image forming apparatus and transmitting the obtained information according to an exemplary embodiment of the present invention; and

FIG. 8 is a diagram illustrating the setting of a connection from a printer to a headset using a Bluetooth protocol.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described more fully with reference to the accompanying drawings.

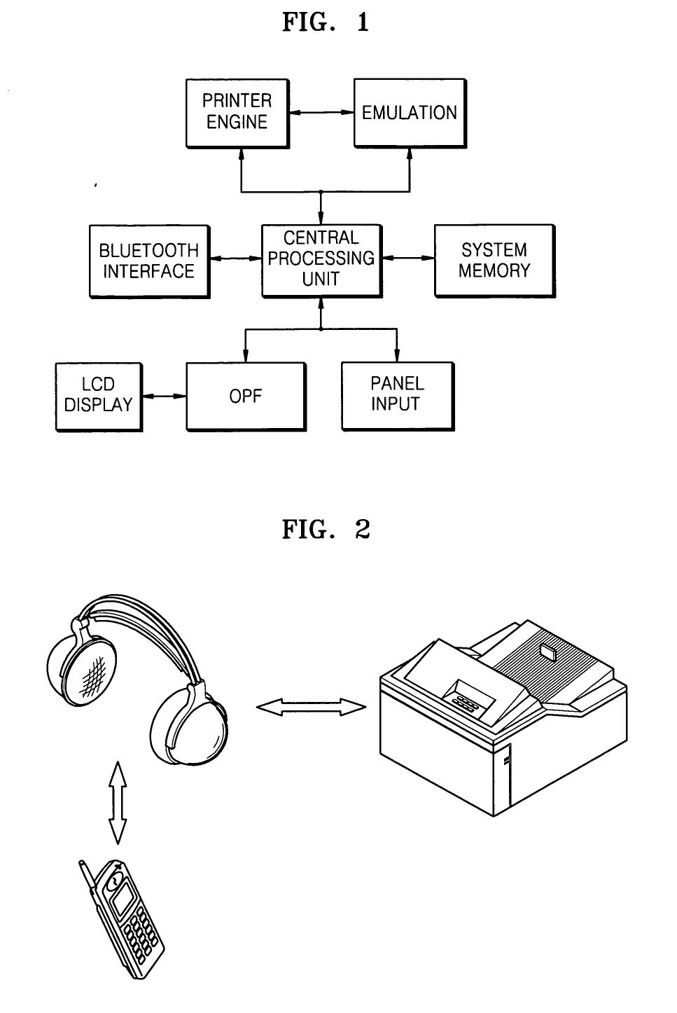

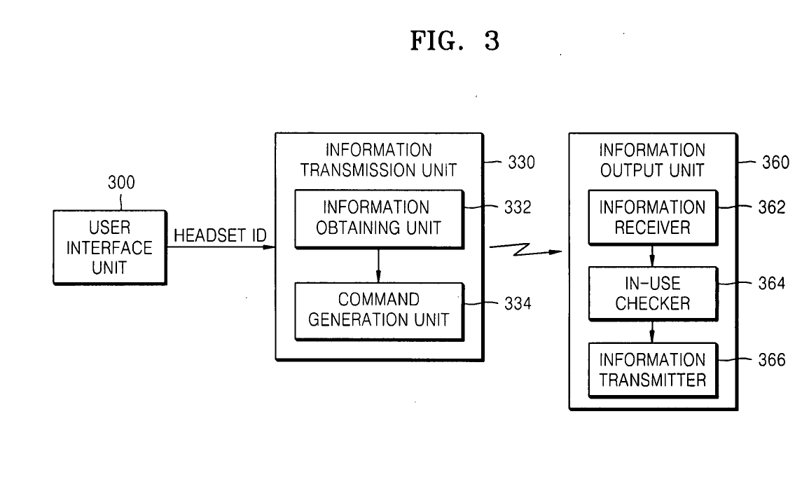

FIG. 1 is a block diagram of an exemplary image forming apparatus of the present invention, and FIG. 2 is a diagram of an exemplary headset for a mobile communication terminal and an exemplary image forming apparatus of the present invention.

FIG. 3 is a block diagram of an apparatus for transmitting information of an image forming apparatus to a headset according to an exemplary embodiment of the present invention. Referring to FIG. 3, the apparatus includes an information transmission unit 330 and an information output unit 360. The apparatus may also include a user interface unit 300.

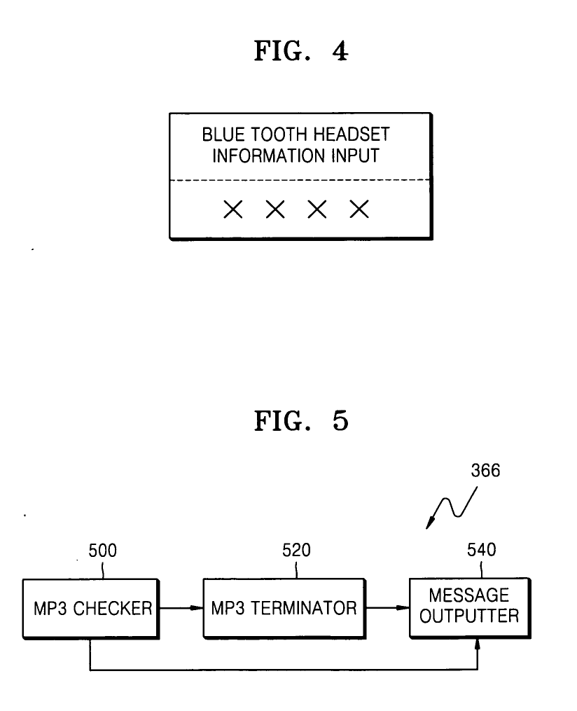

The user interface unit 300 receives headset identification information from a user. FIG. 4 is a diagram of an example of the user interface unit 300. Referring to FIG. 3, the user interface unit 300 can receive headset identification information via a panel of an image forming apparatus.

The information transmission unit 330 transmits information of an image forming apparatus to a headset. The information transmission unit 330 includes an information obtaining unit 332 and a command generation unit 334. The information obtaining unit 332 collects information of the image forming apparatus. The collected image forming apparatus information may comprise state information and error information of the image forming apparatus. For example, the collected image forming apparatus information may include information specifying the state of the image forming apparatus such as print operation information indicating whether a print operation has been terminated. Also, the collected image forming apparatus information may include information regarding errors that may occur in the image forming apparatus such as information regarding whether toner out, paper out, paper jam or the like has occurred in the image forming apparatus.

The command generation unit 334 converts the image forming apparatus information into a command having a smaller data size and transmits the command to a headset corresponding to the headset identification information. For example, information indicating that a print operation has been terminated may be mapped to a value of 1, information indicating that a paper jam has occurred in the image forming apparatus is mapped to a value of 2, and information indicating that toner out has occurred in the image forming apparatus is mapped to a value of 3. Then, these values are transmitted to the headset, thereby reducing the amount of data transmitted to the headset. The headset may be a Bluetooth headset.

The information output unit 360 converts the image forming apparatus information into a voice message and outputs the voice message to a speaker of the headset. The information output unit 360 includes an information receiver 362, an in-use checker 364, and an information transmitter 366. The information receiver 362 receives state information of the image forming apparatus from the image forming apparatus. The in-use checker 364 determines whether the headset is currently in use.

If the in-use checker 364 determines that the headset is currently in use, the information transmitter 366 may terminate the use of the headset and output the voice message to the headset speaker. If the in-use checker 364 determines that the headset is currently not in use, the information transmitter 366 may output the voice message to the headset speaker. Alternatively, if the in-use checker 364 determines that the headset is currently in use, the information transmitter 366 may wait until the use of the headset is terminated and output the voice message to the headset speaker when the use of the headset is terminated.

Examples of the use of the headset may include use of the headset for receiving/making a call or for listening to music.

If the headset is currently in use for making/receiving a call, the information output unit 360 may wait until the use of the headset is terminated. When the use of the headset is terminated, the information output unit 360 converts the image forming apparatus information into a voice message and transmits the voice message to the headset speaker. If the headset is currently not in use, the information output unit 360 readily converts the image forming apparatus information into a voice message and transmits the voice message to the headset speaker. FIG. 5 is a block diagram of the information transmitter 366 of FIG. 3. Referring to FIG. 3, the information transmitter 366 includes an MP3 checker 500, an MP3 terminator 520, and a message outputter 540.

If a mobile communication device is currently in use for making/receiving a call, the MP3 checker 500 may hold the image forming apparatus information in readiness until the use of the mobile communication device is terminated. When the use of the mobile communication device is terminated, the MP3 checker 500 determines whether an MP3 file is currently being reproduced via the headset. On the other hand, if the mobile communication device is currently not in use, the MP3 checker 500 determines whether an MP3 file is currently being reproduced via the headset. For example, if a user is currently making/receiving a call with a cell phone, the MP3 checker 500 may wait until the user finishes the call. When the user finishes the call, the MP3 checker 500 determines whether an MP3 file is currently being reproduced via the headset, in other words, the MP3 checker 500 determines whether the user is currently listening to music. If an MP3 file is currently being reproduced via the headset, the MP3 checker 500 may terminate the reproduction of the MP3 file. The message outputter 540 converts the image forming apparatus information into a voice message and outputs the voice message to the headset speaker if no MP3 file is currently being reproduced via the headset or if the reproduction of an MP3 file has been terminated.

The user interface unit 300 and the information transmission unit 330 may be installed in the image forming apparatus. The information output unit 360 may be installed in the headset.

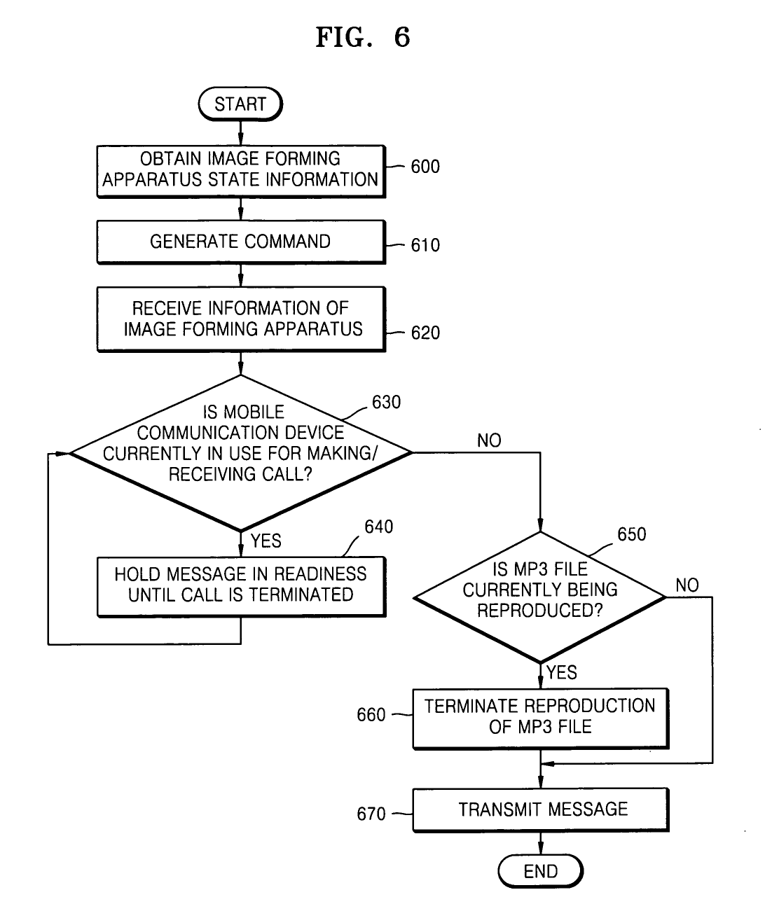

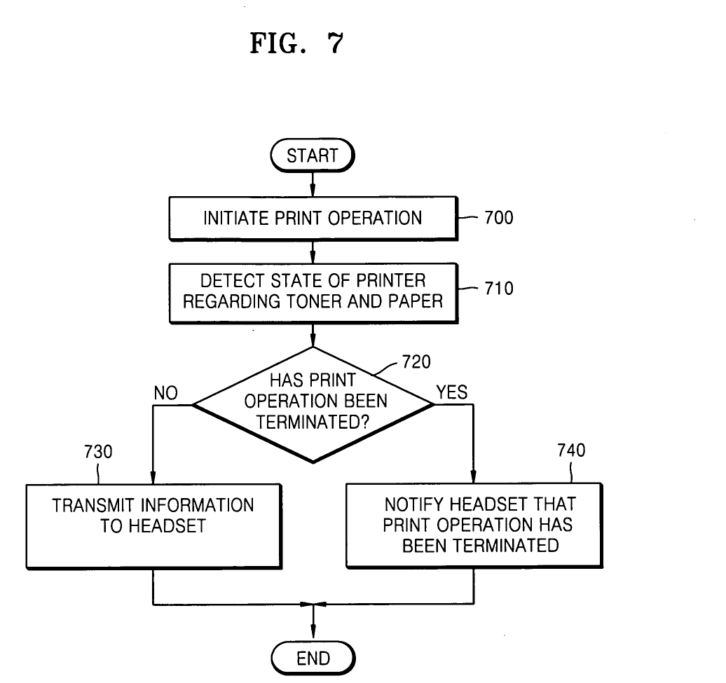

FIG. 6 is a flowchart illustrating a method of transmitting information of an image forming apparatus according to an exemplary embodiment of the present invention, and FIG. 7 is a flowchart illustrating a method of obtaining information of an image forming apparatus and transmitting the obtained information according to an exemplary embodiment of the present invention.

Referring to FIGS. 6 and 7, in operation 700, an image forming apparatus initiates a printing operation. In operation 710, it is determined whether toner out or paper out has occurred in the image forming apparatus. In operation 600, information of the image forming apparatus such as information indicating whether toner out or paper out has occurred in the image forming apparatus is obtained. In operation 610, in order to reduce the amount of data that needs to be transmitted to the headset, the image forming apparatus information is converted into a command, and the command is transmitted to a headset. For example, information indicating that a print operation has been terminated may be mapped to a value of 1, information indicating that paper jam has occurred in the image forming apparatus may be mapped to a value of 2, and information indicating that toner out has occurred in the image forming apparatus may be mapped to a value of 3. Thereafter, these values are transmitted to the headset as commands. The headset may be a Bluetooth headset.

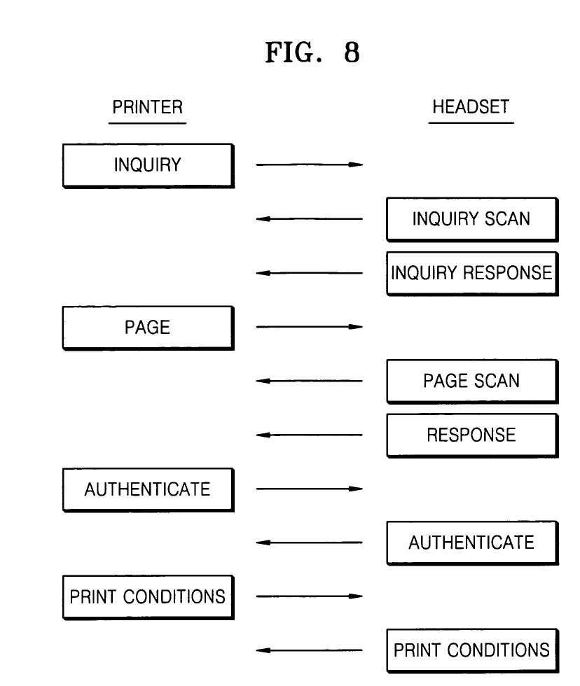

In operation 720, when the state of the image forming apparatus regarding toner and paper is detected, it is determined whether a print operation has been terminated. In operation 740, if the print operation has been terminated, the headset is notified that the print operation has been terminated. In operation 730, if the print operation has not been terminated, the image forming apparatus information is transmitted to the headset. If the headset is a Bluetooth headset, a connection to the headset is set using a Bluetooth protocol, and the command is transmitted to the headset via the connection. FIG. 8 is a diagram illustrating the setting of a connection from a printer to a headset using a Bluetooth protocol.

The information receiver 362 installed in the headset receives the image forming apparatus information and determines whether the headset is currently in use. If the headset is currently not in use, the image forming apparatus information is output to a speaker of the headset as a voice message. On the other hand, if the headset is currently in use, the use of the headset may be terminated, and the image forming apparatus information is transmitted to the headset speaker as a voice message. Alternatively, if the headset is currently in use, the transmission of the image forming apparatus information to the headset may be delayed until the use of the headset is terminated. When the use of the headset is terminated, the image forming apparatus information is output to the headset speaker as a voice message.

In operation 630, it is determined whether, for example, a mobile communication terminal is currently in use for making/receiving a call. In operation 640, if the mobile communication terminal is currently in use for making/receiving a call, the image forming apparatus information is held in readiness. In operation 650, when the use of the mobile communication device is terminated, it is determined whether an MP3 file is currently being reproduced via the headset. In operation 670, if no MP3 file is currently being reproduced via the headset, a state information message is transmitted to the headset. If an MP3 file is currently being reproduced via the headset, the reproduction of the MP3 file is terminated in operation 660, and the state information message is transmitted to the headset in operation 670. The state information message may be transmitted to the headset as a voice message so that a user can hear the state information message via the headset speaker.

If the user uses a Bluetooth headset, the user may be informed of the state of a printer regarding whether a print operation has been terminated via a Bluetooth connection to the Bluetooth headset. If the user is currently listening to music, the playback of music may be terminated, and then, the user may be informed of the state of the printer. If the user is currently making/receiving a call, he/she may be informed of the state of the printer only after he/she finishes the call.

In other words, the user may set a connection to a Bluetooth headset using a panel menu illustrated in FIG. 4 and transmit print data to a printer. Then, the printer prints the print data, connects itself to the Bluetooth headset, and informs the user that the printing of the print data has been terminated. The Bluetooth headset stores a voice message indicating whether a print operation has been terminated and whether toner out, paper out or the like has occurred. Therefore, the Bluetooth headset may output different voice messages to the user according to the state of the printer. In addition, if the user is currently making/receiving a call using the Bluetooth headset, a message indicating that the user cannot be informed of the state of the printer until the user finishes the call and thus needs to be informed of the state of the printer later is kept being transmitted to the printer while preventing the message from being accidentally deleted until the user finishes the call. If the user uses a less important function of the Bluetooth headset such as an MP3 playback function, the execution of the function may be terminated, and information regarding the state of the printer may be readily transmitted to the user. After the transmission of the information regarding the state of the printer to the user is finished, the execution of the function may be resumed.

Exemplary embodiments of the present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet).

According to the present invention, it is possible to inform a user in the vicinity of a printer of various printer state information such as information whether a print operation performed by the printer has been terminated and thus maximize user convenience by transmitting the printer state information directly to a headset without the need to transmit the printer state information first to the user's mobile phone.

While the present invention has been particularly shown and described with reference to exemplary embodiments thereof, it will be understood by those of ordinary skill in the art that various changes in form and details may be made therein without departing from the spirit and scope of the present invention as defined by the following claims and the full scope of equivalents thereof.

What is claimed is:

1. A method of transmitting information of an image forming apparatus, the method comprising:
receiving wireless headset identification information;
transmitting image forming apparatus information to a headset corresponding to the wireless headset identification information; and
outputting the image forming apparatus information to a speaker of the headset.

2. The method of claim 1 wherein the outputting the image forming apparatus information comprises outputting the image forming apparatus information to the speaker of the headset as a voice message.

3. The method of claim 1, wherein the wireless headset identification information is input via a user interface.

4. The method of claim 1, wherein the transmitting information comprises transmitting the image forming apparatus information to a Bluetooth headset using a Bluetooth protocol.

5. The method of claim 1, wherein the image forming apparatus information comprises at least one of state information of the image forming apparatus and error information regarding errors that may occur in the image forming apparatus.

6. The method of claim 1, wherein the outputting comprises:
receiving the image forming apparatus information from the image forming apparatus;
determining whether the headset is currently in use and, if the headset is currently not in use, outputting the image forming apparatus information to the headset speaker as a voice message; and
if the headset is currently in use, terminating the use of the headset and outputting the image forming apparatus information to the headset speaker as a voice message.

7. The method of claim 6, wherein the terminating the use of the headset and the outputting the image forming apparatus information comprise, if the headset is currently in use, outputting the image forming apparatus information to the headset speaker after the use of the headset is terminated by a user of the headset.

8. The method of claim 6, wherein the use of the headset comprises at least one of use of the headset for making/receiving a call and use of the headset for listening to music.

9. An apparatus for transmitting information of an image forming apparatus comprising:
an information transmission unit for transmitting image forming apparatus information to a headset corresponding to wireless headset identification information when the wireless headset identification information is received; and
an information output unit which outputs the image forming apparatus information to a speaker of the headset.

10. The apparatus of claim 9, wherein the image forming apparatus information is output to the speaker of the headset as a voice message.

11. The apparatus of claim 9, further comprising a user interface unit which receives the wireless headset identification information from a user,
wherein the information transmission unit transmits the image forming apparatus information to the headset after receiving the wireless headset identification information.

12. The apparatus of claim 9, wherein the information transmission unit transmits the image forming apparatus information to a Bluetooth headset using a Bluetooth protocol.

13. The apparatus of claim 9, wherein the image forming apparatus information comprises at least one of state information of the image forming apparatus and error information regarding errors that may occur in the image forming apparatus.

14. The apparatus of claim 9, wherein the information output unit comprises:
an information receiver which receives the image forming apparatus information from the image forming apparatus;
an in-use checker which determines whether the headset is in use; and
an information transmitter which outputs the image forming apparatus information to the headset speaker.

15. The apparatus of claim 14, wherein, if the headset is currently in use, the information transmitter terminates the use of the headset and outputs the image forming apparatus information to the headset speaker.

16. The apparatus of claim 14, wherein, if the headset is currently in use, the information transmitter outputs the image forming apparatus information to the headset speaker after the use of the headset is terminated by a user of the headset.

17. The apparatus of claim 15, wherein the use of the headset comprises at least one of use of the headset for making/receiving a call and use of the headset for listening to music.

18. The apparatus of claim 16, wherein the use of the headset comprises at least one of use of the headset for making/receiving a call and use of the headset for listening to music.

19. An image forming apparatus comprising:
a user interface unit which receives headset identification information from a user; and
an information transmission unit which, when the headset identification information is received, transmits information of the image forming apparatus to a headset corresponding to the headset identification information.

20. The image forming apparatus of claim 19, wherein the information transmission unit transmits the image forming apparatus information to a Bluetooth headset using a Bluetooth protocol.

21. A headset comprising:
an information receiver which receives information of an image forming apparatus;
an in-use checker which determines whether the headset is currently in use; and
an information transmitter which outputs the image forming apparatus information to the headset speaker.

22. The headset of claim 21, wherein the information transmitter outputs the image forming apparatus information to the headset speaker as a voice message.

23. The headset of claim 21, wherein if the headset is currently in use, the information transmitter terminates the use of the headset and outputs the image forming apparatus information to the speaker of the headset.

24. The headset of claim 21, wherein, if the headset is currently in use, the information transmitter outputs the image forming apparatus information to the headset speaker after the use of the headset is terminated by a user of the headset.

25. The headset of claim 23, wherein the information receiver receives the image forming apparatus information using a Bluetooth protocol.

26. The headset of claim 24, wherein the information receiver receives the image forming apparatus information using a Bluetooth protocol.

27. The headset of claim 23, wherein the use of the headset comprises use of the headset for making/receiving a call and use of the headset for listening to music.

28. The headset of claim 24, wherein the use of the headset comprises use of the headset for making/receiving a call and use of the headset for listening to music.

29. A computer-readable medium having stored thereon instructions for executing a method of transmitting information of an image forming apparatus, the instructions comprising:
a first set of instructions for receiving wireless headset identification information;
a second set of instructions for transmitting image forming apparatus information to a headset corresponding to the wireless headset identification information; and
a third set of instructions for outputting the image forming apparatus information to a speaker of the headset.

30. The computer readable medium of claim 29 wherein the third set of instructions for outputting the image forming apparatus information comprise instructions for outputting the image forming apparatus information to the speaker of the headset as a voice message.

31. The computer readable medium of claim 29, wherein the first set of instructions comprise instructions for receiving the wireless headset identification information via a user interface.

32. A method of providing information of an image forming apparatus, the method comprising:
transmitting information of an image forming apparatus to a wireless headset;
outputting the image forming apparatus information to a speaker of the wireless headset.

33. The method of claim 32, wherein the transmitting of the information comprises transmitting information of the image forming apparatus directly to the wireless headset.

34. An apparatus for transmitting information of an image forming device comprising:
an information transmission unit for transmitting image forming device information to a wireless headset.

35. The apparatus of claim 34, wherein the image forming device information is transmitted directly to the wireless headset.

36. A wireless headset comprising:
an information receiver which receives information of an image forming apparatus; and
an information transmitter which outputs the image forming apparatus information to a headset speaker.

37. The wireless headset of claim 36, wherein the information of the image forming apparatus is received directly from the image forming apparatus.
